(19) United States
(12) Patent Application Publication
(10) Pub. No.: US 2008/0175147 A1
(43) Pub. Date: Jul. 24, 2008

(54) Admission control for packet connections

(75) Inventor: Jani Lakkakorpi, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/009,401

(22) Filed: Jan. 18, 2008

Related U.S. Application Data
(60) Provisional application No. 60/881,318, filed on Jan. 18, 2007.

(51) Int. Cl. H04L 12/26

(52) U.S. Cl. 370/230

(57) ABSTRACT

The exemplary embodiments of this invention provide a method that includes time stamping packets when the packets enter a queue; when a packet is taken from the queue updating an average queuing delay estimate; and comparing a resulting average queuing delay estimate to an admission threshold for making an admission decision. The exemplary embodiments of this invention also provide a method that includes, in response to at least one slot being granted to a certain connection, updating an average throughput of the connection; dividing the averaged connection throughput by a minimum bandwidth requirement of the connection; calculating an average throughput over all (N) normalized throughputs; and comparing the result to a throughput threshold. Corresponding apparatus and computer program(s) stored in a computer readable medium are also disclosed.

### CLAIM OF PRIORITY FROM COPENDING PROVISIONAL PATENT APPLICATION

This patent application claims priority under 35 U.S.C. §119(e) from Provisional Patent Application No.: 60/881,318, filed Jan. 18, 2007, the disclosure of which is incorporated by reference herein in its entirety.

### TECHNICAL FIELD

The exemplary and non-limiting embodiments of this invention relate generally to wireless communication systems, methods, devices and computer programs and, more specifically, relate to techniques to provide uplink and downlink packet services, such as VoIP services.

### BACKGROUND

Various abbreviations that appear in the specification and/or in the drawing figures are defined as follows:

BS base station

DL downlink (BS to SS)

OFDMA orthogonal frequency division multiplexing with multiple access

QoS quality of service

SS subscriber station

UL uplink (SS to BS)

VoIP voice over internet protocol

WiMAX worldwide interoperability for microwave access (IEEE 802.16)

UGS unsolicited grant service (WiMAX QoS class)

rtPS real-time polling service (WiMAX QoS class)

nrtPS non-real-time polling service (WiMAX QoS class)

ertPS enhanced-real-time polling service (WiMAX QoS class)

BE best effort (WiMAX QoS class)

In general, the QoS of VoIP connections cannot be guaranteed without proper connection admission control.

One may assume that the scheduler at a WiMAX BS will give priority to real time connections, including VoIP connections, i.e., they are assigned (both uplink and downlink) slots before any other connections. However, there is a point after which one cannot admit any new VoIP connections without experiencing degradation in the QoS (due to increased packet delay and packet loss) of all of the VoIP connections handled by the BS.

One may further assume that simple calculations may be performed in order to determine if there are sufficient slots for handling new VoIP connections. However, this can be quite difficult when OFDMA is used in the wireless link. This is true at least for the reason that OFDMA presents a two-dimensional (time and space) slot structure, which makes it difficult to allocate slots in an optimal manner.

Reference may be made to a document entitled: IEEE 802.16 WiMAX, Alexander Sayenko, Telecommunications laboratory, MIT department, University of Jyväskylä, Finland. This document, incorporated by reference herein in its entirety, provides an overview of WiMAX frame structures, modulation types and the like.

Reference may also be made to a document entitled: Quality of Service Support in IEEE 802.16 Networks, Claudio Cicconetti et al., IEEE Network, March/April 2006, pgs. 50-55.

### SUMMARY OF THE EXEMPLARY EMBODIMENTS

The foregoing and other problems are overcome, and other advantages are realized, by the use of the exemplary embodiments of this invention.

In a first aspect thereof the exemplary embodiments provide a method that includes time stamping packets when the packets enter a queue; when a packet is taken from the queue updating an average queuing delay estimate; and comparing a resulting average queuing delay estimate to an admission threshold for making an admission decision.

In a further aspect thereof the exemplary embodiments provide an apparatus that includes a queue for storing packets a packet scheduler configurable to time stamp arriving packets when stored in the queue and further configurable, in response to a packet being taken from the queue, to update an average queuing delay estimate and to compare a resulting average queuing delay estimate to an admission threshold for making an admission decision.

In another aspect thereof the exemplary embodiments provide a computer readable medium that stores computer executable program instructions, execution of which results in operations that comprise time stamping packets when the packets enter a queue; when a packet is taken from the queue updating an average queuing delay estimate; and comparing a resulting average queuing delay estimate to an admission threshold for making an admission decision.

In another aspect thereof the exemplary embodiments provide a method that includes, in response to at least one slot being granted to a certain connection, updating an average throughput of the connection; dividing the averaged connection throughput by a minimum bandwidth requirement of the connection; calculating an average throughput over all (N) normalized throughputs; and comparing the result to a throughput threshold.

In a further aspect thereof the exemplary embodiments provide an apparatus having a wireless communication interface and an admission function configurable for operation with a plurality of mobile devices using connections. The admission function is responsive to at least one slot being granted to a certain connection to update an average throughput of the connection and to divide the averaged connection throughput by a minimum bandwidth requirement of the connection. The admission function is further configurable to calculate an average throughput over all (N) normalized throughputs and to compare the result to a throughput threshold.

In a still aspect thereof the exemplary embodiments provide a computer readable medium that stores computer executable program instructions, execution of which results in operations that comprise, in response to at least one slot being granted to a certain connection, updating an average throughput of the connection; dividing the averaged connection throughput by a minimum bandwidth requirement of the connection; calculating an average throughput over all (N) normalized throughputs; and comparing the result to a throughput threshold.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIGS. 2 and 3 are logic flow diagrams that are descriptive of methods, and the execution of computer programs, related to admission control in accordance with the exemplary embodiments of this invention.

FIG. 4 provides an example of QoS functions within the BS and SS shown in FIG. 1.

### DETAILED DESCRIPTION

The exemplary embodiments of this invention overcome the problems discussed above and enable admission control that is independent of the physical layer, thereby simplifying the implementation.

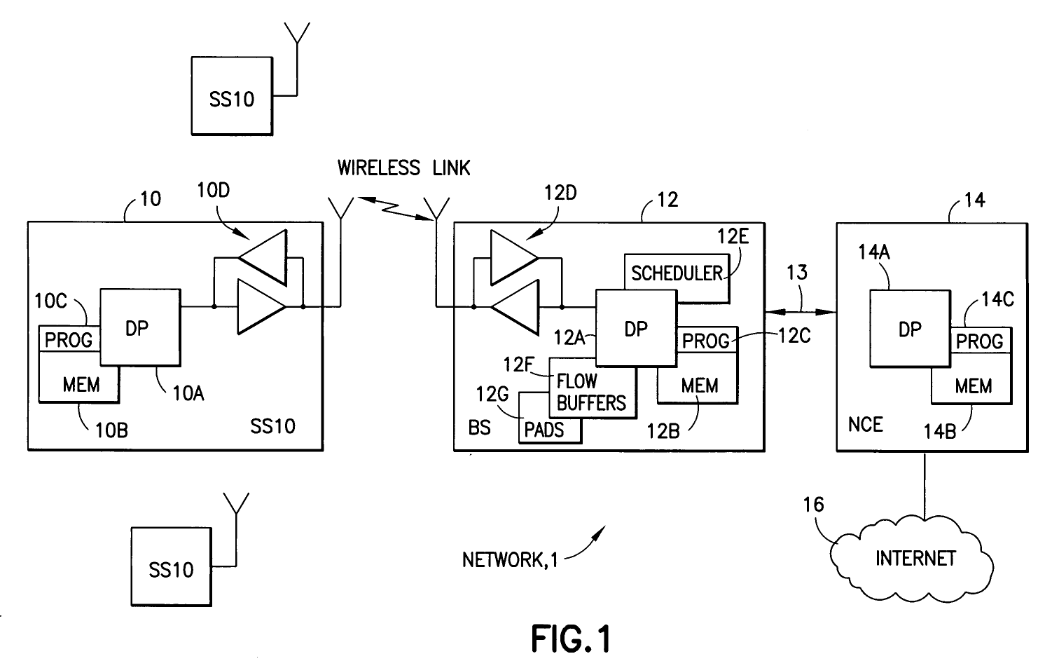

Reference is made first to FIG. 1 for illustrating a simplified block diagram of various electronic devices that are suitable for use in practicing the exemplary embodiments of this invention. In FIG. 1 a wireless network 1 is adapted for communication with a SS 10 via a BS 12. The network 1 may include some type of network control element (NCE) 14 that provides connectivity to external data communications networks such as the Internet 16. The SS 10 includes a data processor (DP) 10A, a memory (MEM) 10B that stores a program (PROG) 10C, and a suitable radio frequency (RF) transceiver 10D for bidirectional wireless communications with the BS 12, which also includes a DP 12A, a MEM 12B that stores a PROG 12C, and a suitable RF transceiver 12D. The BS 12 is coupled via a data path 13 to the NCE 14 that also includes a DP 14A and a MEM 14B storing an associated PROG 14C. At least the PROG 12C may be assumed to include program instructions that, when executed by the associated DP 12A, enables the electronic device to operate in accordance with the exemplary embodiments of this invention, as will be discussed below in greater detail.

In practice, there will typically be a population of SSs 10 that are served by the BS 12, having potentially different types of connection and QoS requirements.

In general, the exemplary embodiments of this invention may be implemented at least in part by computer software executable by the DP 12A of the BS 12, or by hardware, or by a combination of software (and firmware) and hardware.

In the exemplary embodiments of this invention the network 1 is or includes a WiMAX network that is generally compliant with IEEE 802.16e™ specifications and standards. However, it should be realized that at least certain aspects of these exemplary embodiments may be used with other types of wireless communications networks.

The various embodiments of the SS 10 can include, but are not limited to, wireless phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

For the purposes of describing the exemplary embodiments of this invention the BS 12 can be assumed to include at least one scheduler 12E, flow buffers 12F (also referred to as packet queues) and a packet arrival data structure (PA_DS). 12G. At least the flow buffers 12F and the PA_DS 12G may be embodied as locations in the memory 12B. The at least one scheduler 12E may be embodied in whole or in part by instructions in the program 12C, and may include a DL scheduler and an UL scheduler.

Further in this regard, note that the ratio of DL and UL slots in a WiMAX frame can be static or dynamic. In both cases, however, DL and UL slots are scheduled separately. A DL scheduler uses per-connection queue sizes as its input whereas an UL (grant) scheduler uses bandwidth requests (sent by the SSs 10 or periodically created in the BS 12). The UL scheduler can be referred to as a grant scheduler since it grants slots to the SSs 10.

The design of the DL and UL (grant) schedulers, collectively shown in FIG. 1 as the scheduler 12E, can be similar. For example, both can be implemented as (Deficit) Round Robin schedulers. However, the UL scheduler may be more complex than the DL scheduler. For example, the UL scheduler may exhibit additional complexity if it is desirable to support all five WiMAX QoS classes (UGS, ertPS, rtPS, nrtPS and BE).

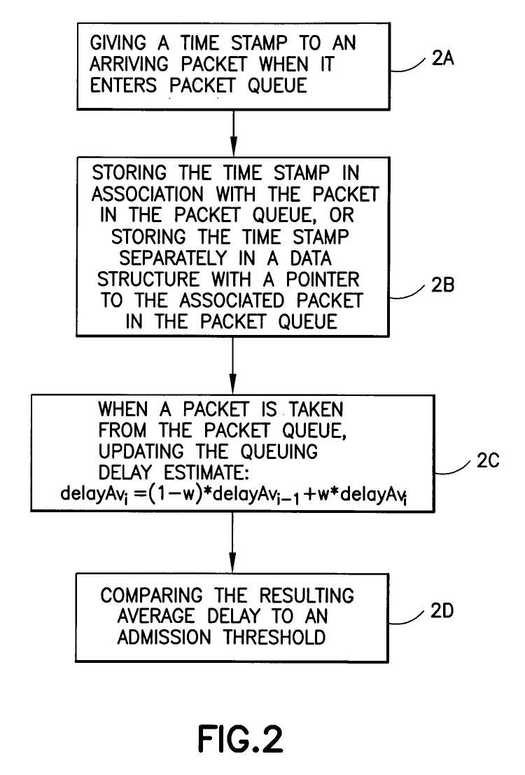

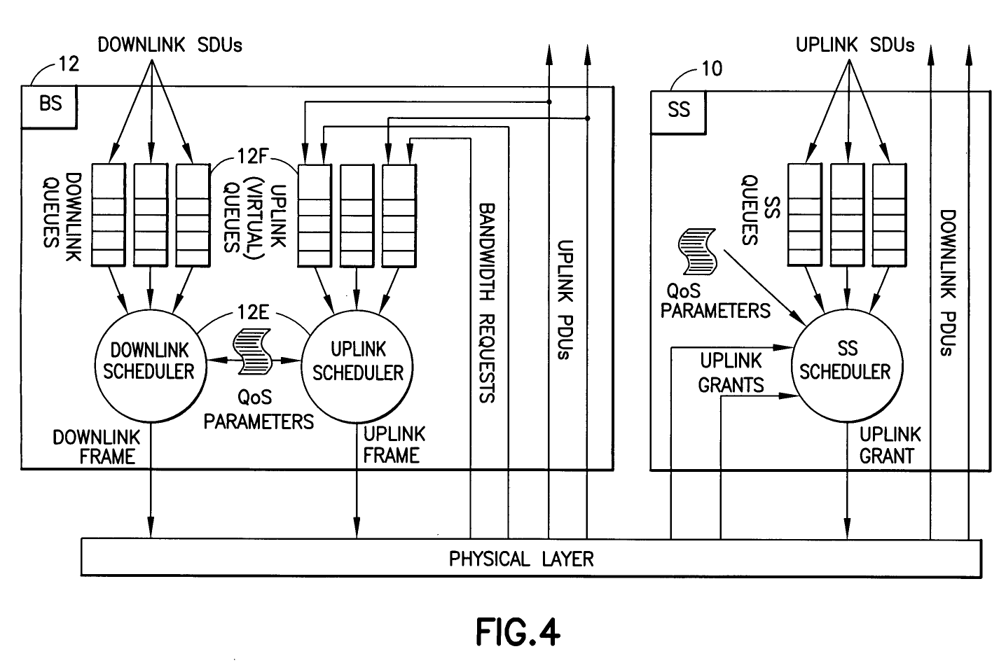

Further reference with this regard can be had to FIG. 4, which illustrates QoS functions within the BS 12 and SS 10. FIG. 4 is adapted from FIG. 2 of the above-referenced document entitled: Quality of Service Support in IEEE 802.16 Networks, Claudio Cicconetti et al., IEEE Network, March/April 2006, pgs. 50-55. FIG. 4 shows the UL and DL BS 12 schedulers and associated UL (virtual) and DL queues.

It may be noted that a (rather simpler) queuing delay-based admission control is possible for the DL direction only. As one cannot reliably assume that the SSs 10 are able to insert or associate valid timestamps with UL packets, the queuing delay-based admission control approach is not preferred for use in the UL direction. As such, and as will be made more apparent below, it may be preferred to use a throughput/virtual queue size-based admission control technique for the UL direction.

The exemplary embodiments of this invention provide in certain aspects thereof a packet delay/throughput based connection admission control mechanism for VoIP connections at the WiMAX BS 12. As voice connections are (usually) bi-directional, the use of the exemplary embodiments of this invention ensures the presence of sufficient resources for both the UL and DL.

It should be noted, however, that the exemplary embodiments of this invention can be employed for other types of packet flows and connections than VoIP, and are particularly well suited for those types of connections requiring minimal latency and a correspondingly stringent QoS (e.g., streaming video).

It may be assumed that delay and throughput thresholds (after which no new connections are admitted) are configurable parameters.

For the DL one may use the average queuing time of all VoIP packets in the admission decisions. The average queuing time may be considered to be related to the amount of time that a voice packet has to wait in its flow-based buffer 12F before it is passed to the lower layer(s) (e.g., to the physical (PHY) layer) and is sent over the air interface. An arriving voice packet is given a time stamp when it enters the queue. This time stamp can be stored with the voice packet in the flow buffer 12F, or it may be stored separately in the PA_DS 12G with a pointer to the associated voice packet in the flow buffers 12F.

For the UL direction, throughput information from the scheduler 12E may be preferred for use, as this avoids a requirement to rely on possible packet timestamps inserted by the SS 10 prior to sending an UL packet.

A simplest assumption is that the radio interface creates the only packet flow bottleneck. However, it is possible to extend the scope of the exemplary embodiments of this invention to cover the transmission network as well. Downlink voice packet delays can be used, where voice packets are given a timestamp when they enter the radio access network. When the packet arrives at the BS 12, one may calculate the delay and estimate the rate of congestion on the transmission links.

For the DL it is preferred to use exponential averaging for the queuing delay estimation. Whenever a packet is taken from the flow buffer 12F the queuing delay estimate is updated:

delayAvᵢ=(1−w)*delayAvᵢ₋₁+w*delayᵢ,

where w is an averaging weight that determines how fast or slowly the delay average changes.

This figure is used in admission control and compared to a DL delay threshold (e.g., 20 ms).

Note that it is not necessary to actually mark the DL VoIP packets with a timestamp when they enter their queue (flow buffers 12F). Instead, the PS-DS 12G can be used to record packet arrival times, with pointers to the corresponding queued packets in the flow buffers 12F.

For the UL there are at least two suitable techniques to estimate the congestion.

First, one may opportunistically assume/require that the packet source (e.g., the VoIP application) at the SS 10 equips its UL packets with a timestamp. When the packet arrives at the BS 12 the UL delay through the bottleneck (radio interface) can be readily determined by comparing the actual time of arrival to the timestamp, and to then use this value in the admission decision in a manner somewhat similar to downlink delay estimation.

Second, a more realistic alternative (that does not rely on the operation of the SSs 10) measures the frequency of how often UL VoIP connections are granted slots, and to then calculate the UL throughputs using the slot size (which is a function of the current modulation scheme of the connection) and the gap between a current slot grant and a previous slot grant.

With regard to using the slot size and the gap between slot grants, assume for example a grant in every fourth frame of four slots of size six bytes, where the slot size depends on the current modulation scheme of the connection. If one assumes a frame length of 5 ms, there is a throughput of 4×6×8/0.02=9600 bits per second.

In this second technique, whenever a slot (or several slots) is granted to a certain connection, the average throughput of the connection may be updated using the following formula:

grantTime_{i,t}=NOW

tput_{i,t}=grantedBits_{i,t}/(NOW−grantTime_{i,t-1})

tputAv_{i,t}=(1−w)*tputAv_{i,t-1}+w*tput_{i,t};

The averaged connection throughput is then divided by the minimum bandwidth requirement (WiMAX QoS parameter) of the connection i:

tputNormalizedᵢ=tputAv_{i,t}/bwreqᵢ.

Periodically, the average can be calculated over all (N) normalized throughputs:

$${tputNormalizedAv}_{t} = \frac{{\sum }_{i = 1}^{N} {tputNormalized}_{i , t}}{N} .$$

The result is used in the admission control process and compared to the relevant throughput threshold (e.g., 1).

In a further embodiment of a technique to estimate the UL congestion the grant scheduler 12E at the BS 12 maintains a set of virtual queues that are updated whenever new slots are assigned to connections (enque) and also whenever the slots are actually granted (deque). In this case appropriate thresholds are defined after which new connections are not admitted, depending on the state of the virtual queues.

While one may assume that the scheduler 12E uses round-robin scheduling for both UL and DL VoIP connections, this particular type of scheduling is not a requirement for implementing the admission control mechanism.

Based on the foregoing it should be apparent that the exemplary embodiments of this invention provide a method, apparatus and computer program stored in a computer readable medium to provide admission control based at least in part on an estimate of a queuing delay of packets intended for DL transmission. Referring to FIG. 2, in accordance with an exemplary method an average queuing time of all packets to be used in making an admission decision is determined to be related to an amount of time that a voice packet has to wait in its flow-based buffer 12F before it is passed to a lower layer. At Block 2A an arriving packet is given a time stamp when it enters the queue 12F, where at Block 2B the time stamp is stored in association with the packet in the flow buffer 12F, or is stored separately in the PA_DS 12G with a pointer to the associated packet in the flow buffer 12F. At Block 2C, when a packet is taken from the flow buffer 12F the queuing delay estimate is updated by:

delayAvᵢ=(1−w)*delayAvᵢ₋₁+w*delayᵢ.

At Block 2D the resulting average delay is compared to an admission threshold.

The method of the preceding paragraph may be executed in the BS 12, and the packets may be VoIP packets.

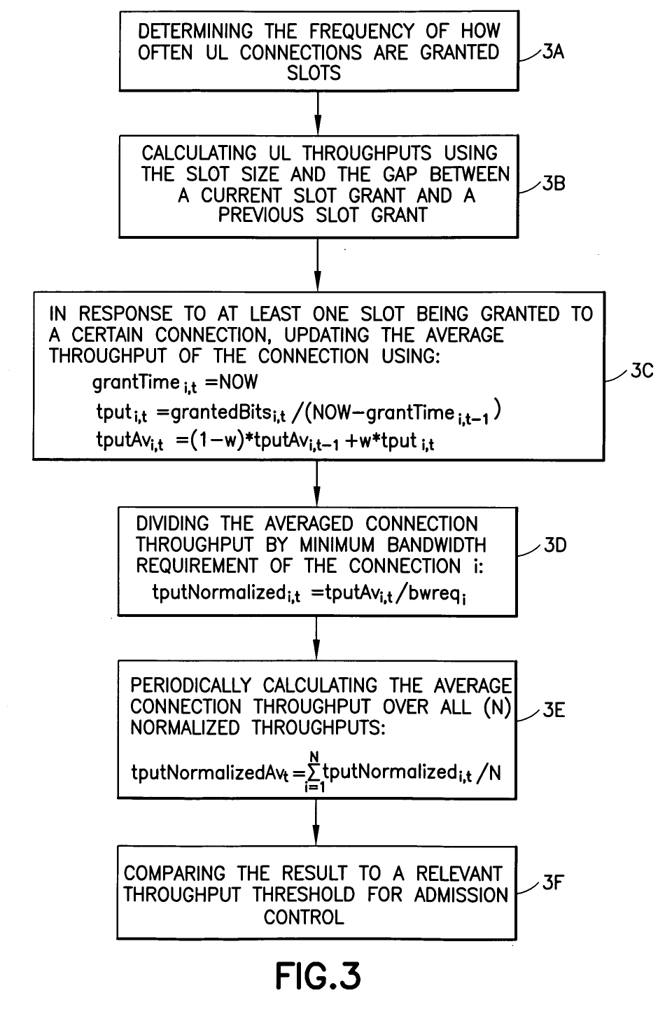

Also based on the foregoing description it should be apparent that the exemplary embodiments of this invention provide a method, apparatus and computer program stored in a computer readable medium to provide admission control based at least in part on an estimate of a queuing delay of UL packets. Referring to FIG. 3, in accordance with another exemplary method at Block 3A a measure is made of the frequency of how often UL connections are granted slots, and at Block 3B the UL throughputs are calculated using the slot size and the gap between a current slot grant and a previous slot grant. At Block 3C, in response to at least one slot being granted to a certain connection, the average throughput of the connection is updated using the following formula:

grantTime_{i,t}=NOW

tput_{i,t}=grantedBits_{i,t}/(NOW−grantTime_{i,t-1})

tputAv_{i,t}=(1−w)*tputAv_{i,t-1}+w*tput_{i,t};

and at Block 3D the averaged connection throughput is divided by the minimum bandwidth requirement of the connection i:

tputNormalized_{i,t}=tputAv_{i,t}/bwreqᵢ.

The method further includes, at Block 3E, periodically calculating the average connection throughput over all (N) normalized throughputs:

$${tputNormalizedAv}_{t} = \frac{{\sum }_{i = 1}^{N} {tputNormalized}_{i , t}}{N} ,$$

and at Block 3F the result is compared to a relevant throughput threshold for admission control.

The method of the preceding paragraph may be executed in the BS 12, and the packets may be VoIP packets.

The various blocks shown in FIGS. 2 and 3 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, and as was noted previously, while the exemplary embodiments have been described above in the context of the WiMAX system it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
time stamping packets when the packets enter a queue;
when a packet is taken from the queue updating an average queuing delay estimate; and
comparing a resulting average queuing delay estimate to an admission threshold for making an admission decision.

2. The method of claim 1, where time stamps are stored in association with packets in the queue.

3. The method of claim 1, where time stamps are each stored separate from the packets with a pointer to a corresponding packet in the queue.

4. The method of claim 1, executed in a base station of a wireless communication network.

5. The method of claim 1, where the packets comprise VoIP packets.

6. The method of claim 1, where the packets are queued for downlink transmission from a base station to at least one subscriber station.

7. The method of claim 1, where the average queuing delay estimate is updated in accordance with an expression:
delayAvᵢ=(1−w)*delayAvᵢ₋₁+w*delayᵢ,
where w is an averaging weight.

8. An apparatus comprising:
a queue for storing packets; and
a packet scheduler configurable to time stamp arriving packets when stored in the queue and further configurable, in response to a packet being taken from the queue, to update an average queuing delay estimate and to compare a resulting average queuing delay estimate to an admission threshold for making an admission decision.

9. The apparatus of claim 8, where time stamps are stored in association with packets in the queue.

10. The apparatus of claim 8, where time stamps are each stored separate from the packets with a pointer to a corresponding packet in the queue.

11. The apparatus of claim 8, embodied in a base station of a wireless communication network.

12. The apparatus of claim 8, where the packets comprise VoIP packets.

13. The apparatus of claim 8, where the packets are queued for downlink transmission from a base station to at least one subscriber station, and further comprising a transmitter for transmitting the packets.

14. The apparatus of claim 8, where the average queuing delay estimate is updated in accordance with an expression:
delayAvᵢ=(1−w)*delayAvᵢ₋₁+w*delayᵢ,
where w is an averaging weight.

15. A computer readable medium that stores computer executable program instructions, execution of which results in operations that comprise:
time stamping packets when the packets enter a queue;
when a packet is taken from the queue updating an average queuing delay estimate; and
comparing a resulting average queuing delay estimate to an admission threshold for making an admission decision.

16. The computer readable medium of claim 15, where time stamps are stored in association with packets in the queue.

17. The computer readable medium of claim 15, where time stamps are each stored separate from the packets with a pointer to a corresponding packet in the queue.

18. The computer readable medium of claim 15, embodied in a base station of a wireless communication network, where the packets are queued for downlink transmission from a base station to at least one subscriber station.

19. The computer readable medium of claim 15, where the packets comprise VoIP packets.

20. The computer readable medium of claim 15, where the average queuing delay estimate is updated in accordance with an expression:
delayAvᵢ=(1−w)*delayAvᵢ₋₁+w*delayᵢ,
where w is an averaging weight.

21. A method, comprising:
in response to at least one slot being granted to a certain connection, updating an average throughput of the connection;
dividing the averaged connection throughput by a minimum bandwidth requirement of the connection;
calculating an average throughput over all (N) normalized throughputs; and
comparing the result to a throughput threshold.

22. The method of claim 21, where
updating the average throughput of the connection uses the expressions:
grantTime_{i,t}=NOW
tput_{i,t}=grantedBits_{i,t}/(NOW−grantTime_{i,t-1})
tputAv_{i,t}=(1−w)*tputAv_{i,t-1}+w*tput_{i,t};
where dividing the averaged connection throughput by a minimum bandwidth requirement of the connection uses the expression:
tputNormalized_{i,t}=tputAv_{i,t}/bwreqᵢ;
and where calculating an average throughput over all (N) normalized throughputs uses the expression:
$${tputNormalizedAv}_{t} = \frac{{\sum }_{i = 1}^{N} {tputNormalized}_{i , t}}{N} .$$

23. The method of claim 21, executed in a base station of a wireless communication network.

24. An apparatus, comprising:
a wireless communication interface; and
an admission function configurable for operation with a plurality of mobile devices using connections, said admission function being responsive to at least one slot being granted to a certain connection to update an average throughput of the connection and to divide the averaged connection throughput by a minimum bandwidth requirement of the connection, and further configurable to calculate an average throughput over all (N) normalized throughputs and to compare the result to a throughput threshold.

25. The apparatus of claim 24, where
updating the average throughput of the connection uses the expressions:
grantTime_{i,t}=NOW
tput_{i,t}=grantedBits_{i,t}/(NOW−grantTime_{i,t-1})
tputAv_{i,t}=(1−w)*tputAv_{i,t-1}+w*tput_{i,t};
where dividing the averaged connection throughput by a minimum bandwidth requirement of the connection uses the expression:
tputNormalized_{i,t}=tputAv_{i,t}/bwreqᵢ;
and where calculating an average throughput over all (N) normalized throughputs uses the expression:
$${tputNormalizedAv}_{t} = \frac{{\sum }_{i = 1}^{N} {tputNormalized}_{i , t}}{N} .$$

26. The apparatus of claim 24, embodied in a base station of a wireless communication network.

27. A computer readable medium that stores computer executable program instructions, execution of which results in operations that comprise:
in response to at least one slot being granted to a certain connection, updating an average throughput of the connection;
dividing the averaged connection throughput by a minimum bandwidth requirement of the connection;
calculating an average throughput over all (N) normalized throughputs; and
comparing the result to a throughput threshold.

28. The computer readable medium of claim 27, where
updating the average throughput of the connection uses the expressions:
grantTime_{i,t}=NOW
tput_{i,t}=grantedBits_{i,t}/(NOW−grantTime_{i,t-1})
tputAv_{i,t}=(1−w)*tputAv_{i,t-1}+w*tput_{i,t};
where dividing the averaged connection throughput by a minimum bandwidth requirement of the connection uses the expression:
tputNormalized_{i,t}=tputAv_{i,t}/bwreqᵢ;
and where calculating an average throughput over all (N) normalized throughputs uses the expression:
$${tputNormalizedAv}_{t} = \frac{{\sum }_{i = 1}^{N} {tputNormalized}_{i , t}}{N} .$$

29. The computer readable medium of claim 27, embodied in a base station of a wireless communication network.
